(19) United States
(12) Patent Application Publication
(10) Pub. No.: US 2020/0401910 A1
(43) Pub. Date: Dec. 24, 2020

(54) INTELLIGENT CAUSAL KNOWLEDGE EXTRACTION FROM DATA SOURCES

(71) Applicant: INTERNATIONAL BUSINESS MACHINES CORPORATION, Armonk, NY (US)

(72) Inventors: Oktie HASSANZADEH, Briarcliff Manor, NY (US); Michael PERRONE, YORKTOWN HEIGHTS, NY (US); Shirin SOHRABI ARAGHI, Briarcliff manor, NY (US); Mark FEBLOWITZ, Winchester, MA (US); Debarun BHATTACHARJYA, New York, NY (US); Michael KATZ, Elmsford, NY (US); Kavitha SRINIVAS, RYE, NY (US)

(73) Assignee: INTERNATIONAL BUSINESS MACHINES CORPORATION, Armonk, NY (US)

(21) Appl. No.: 16/445,061

(22) Filed: Jun. 18, 2019

(51) Int. Cl. G06N 5/02; G06F 17/27; G06K 9/62; G06N 20/00; G06F 16/901; G06F 16/903

(52) U.S. Cl. CPC G06N 5/025; G06F 17/2785; G06F 16/903; G06N 20/00; G06F 16/9024; G06K 9/6215

(57) ABSTRACT

Embodiments are provided for intelligent causal knowledge analysis from data sources in a computing system by a processor. Multiple communications may be identified from one or more data sources. One or more causal statements having a cause-effect relationship may be extracted from the plurality of communications.

### BACKGROUND OF THE INVENTION

### Field of the Invention

The present invention relates in general to computing systems, and more particularly, to various embodiments for intelligent causal knowledge analysis from data sources by a processor.

### Description of the Related Art

In today's society, consumers, businesspersons, educators, and others communicate over a wide variety of mediums in real time, across great distances, and many times without boundaries or borders. With the increased usage of computing networks, such as the Internet, humans are currently inundated and overwhelmed with the amount of information available to them from various structured and unstructured sources. Due to the recent advancement of information technology and the growing popularity of the Internet, a wide variety of computer systems have been used in machine learning. Machine learning is a form of artificial intelligence (“AI”) that is employed to allow computers to evolve behaviors based on empirical data.

### SUMMARY OF THE INVENTION

Various embodiments of intelligent causal knowledge analysis from data sources in a computing system by a processor are provided. In one embodiment, by way of example only, a method for providing intelligent causal knowledge analysis from data sources in a computing system, again by a processor, is provided. Multiple communications may be identified from one or more data sources. One or more causal statements having a cause-effect relationship may be extracted from the plurality of communications. In an additional aspect, a corpus of text documents may be received as input data. performs identification of causal statements in the input corpus, extracts cause-effect pairs from the statements, and provides retrieval and analysis functions over the extracted collection of cause-effect pairs

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram depicting an exemplary cloud computing node according to an embodiment of the present invention;

FIG. 2 is an additional block diagram depicting an exemplary cloud computing environment according to an embodiment of the present invention;

FIG. 3 is an additional block diagram depicting abstraction model layers according to an embodiment of the present invention;

FIG. 4 is a block diagram depicting an operation mode for intelligent causal knowledge analysis from data sources in which various aspects of the present invention may be realized;

FIG. 5 is an additional block diagram depicting an operation mode for intelligent causal knowledge analysis and/or extraction from data sources in which various aspects of the present invention may be realized;

FIG. 6 is a flowchart diagram depicting an exemplary method for providing intelligent causal knowledge analysis and/or extraction in a computing environment by a processor in which aspects of the present invention may be realized; and

FIG. 7 is a flowchart diagram depicting an additional exemplary method for providing intelligent causal knowledge analysis and/or extraction in a computing environment by a processor, again in which aspects of the present invention may be realized.

### DETAILED DESCRIPTION OF THE DRAWINGS

As a preliminary matter, computing systems may include large scale computing called “cloud computing,” in which resources may interact and/or be accessed via a communications system, such as a computer network. Resources may be software-rendered simulations and/or emulations of computing devices, storage devices, applications, and/or other computer-related devices and/or services run on one or more computing devices, such as a server. For example, a plurality of servers may communicate and/or share information that may expand and/or contract across servers depending on an amount of processing power, storage space, and/or other computing resources needed to accomplish requested tasks. The word “cloud” alludes to the cloud-shaped appearance of a diagram of interconnectivity between computing devices, computer networks, and/or other computer related devices that interact in such an arrangement.

Currently, capturing and representing causal knowledge is a challenging problem in artificial intelligence (“AI”) computing systems, with important applications in various domains such as, for example, healthcare, legal, and enterprise risk management. For example, extracting causal knowledge from text, with the goal of answering questions like “could X cause Y?”, “what could X cause?”, or “what leads to Y”?, where X and Y are phrases that, for example, describe an event or condition such as: 1) “higher taxes” “stock market crash”, and “an increase in inflation rate” (finance domain), 2) “influenza”, “taking medicine”, and “extended exposure to pollution” (healthcare domain), 3) “broken brake pads”, “crack in windshield”, and “old engine oil” (vehicle maintenance).

While an AI operation may be used for causal discovery and modeling from structured data and events, a need exist for employing an AI operation for solving the challenge of extracting causal knowledge described in natural language within a data source (e.g., a text document), without placing restrictions on causes and effects such as, for example, by not restricting the causes and effects to events with a particular semantic representation.

Accordingly, the present invention provides a solution for effective analysis and/or extraction of cause-effect pairs from a corpus of text data (e.g., text documents) and locating semantically related causes and effects in order to answer causal questions along with providing evidence from the input text corpus. In one aspect, the present invention provides for intelligent causal knowledge analysis and/or extraction from data sources in a computing system. Multiple communications (e.g., structured and/or unstructured data) may be identified from one or more data sources. One or more causal statements having a cause-effect relationship may be extracted from the plurality of communications.

In an additional aspect, an intelligent causal knowledge analysis and extraction system of various embodiments described herein may perform an AI operation such as, for example, a natural language processing (“NLP”) operation. The intelligent causal knowledge analysis and extraction system may perform an extraction of cause-effect pairs from an input text corpus and may provide a semantic similarity search over “cause” and “effect” clauses/sentences of text data for effective causal relation analysis for an input cause and/or effect. Also, the intelligent causal knowledge analysis and extraction system may perform an analysis and extraction of cause-effect pairs without any semantic restrictions on cause and effect data/communications (e.g., text data such as, for example, sentences, clause, phrases, etc.) without requiring labeled training data.

In an additional embodiment, a corpus of text data (e.g., text documents) may be received as input. The corpus of text data (e.g., text documents) may be ingested and transformed into a collection of clauses/sentences and phrases that may be used in: 1) a causal knowledge extraction engine, which identifies sentences that are likely to be causal statements, and then extracts cause and effect phrases from these causal sentences, and 2) a semantic embeddings engine, which builds distributed representations of the words, phrases, and clauses/sentences in the corpus of text data that are then used to handle the variety of representations of causes and effects in natural language, and enable effective retrieval and analysis of the extracted cause-effect pairs.

The present invention enables various queries/questions, answers, and analysis tasks using the extracted causal knowledge. For example, the intelligent causal knowledge extraction system, as described herein, may be used to answer queries/questions in a variety of forms, structures, and semantic structures such as, for example, “could X cause Y?”, “What could X cause?”, or “What leads to Y”? where “X” and “Y” are generic/general phrases without any constraints. The query/question and answering operations performed via the intelligent causal knowledge extraction system may be: 1) based on direct lookup over an index of all the extracted cause-effect pairs, 2) based on a similarity search for retrieving cause-effect pairs with causes similar to a defined parameter/variable (e.g., “X”) and/or effects similar to an additional/alternative defined parameter/variable (e.g., “Y”), 3) based on creating a causal knowledge graph, and/or 4) based on use of AI planning based operations to enable efficient and effective analysis of plausible paths from X and/or to Y in the causal graph. A score may be assigned to each answer, and evidence from the input corpus may be provided to support the answer.

It should be noted as described herein, the term “intelligent” (or “cognitive/cognition”) may be relating to, being, or involving conscious intellectual activity such as, for example, thinking, reasoning, or remembering, that may be performed using a machine learning. In an additional aspect, cognitive or “intelligent may be the mental process of knowing, including aspects such as awareness, perception, reasoning and judgment. A machine learning system may use artificial reasoning to interpret data from one or more data sources (e.g., sensor based devices or other computing systems) and learn topics, concepts, and/or processes that may be determined and/or derived by machine learning.

In an additional aspect, cognitive or “intelligent” may refer to a mental action or process of acquiring knowledge and understanding through thought, experience, and one or more senses using machine learning (which may include using sensor based devices or other computing systems that include audio or video devices). Cognitive/intelligent may also refer to identifying patterns of behavior, leading to a “learning” of one or more events, operations, or processes. Thus, the intelligent model may, over time, develop semantic labels to apply to observed behavior and use a knowledge domain or ontology to store the learned observed behavior. In one embodiment, the system provides for progressive levels of complexity in what may be learned from the one or more events, operations, or processes.

In an additional aspect, the term intelligent may refer to an intelligent system. The intelligent system may be a specialized computer system, or set of computer systems, configured with hardware and/or software logic (in combination with hardware logic upon which the software executes) to emulate human cognitive functions. These intelligent systems apply human-like characteristics to convey and manipulate ideas which, when combined with the inherent strengths of digital computing, can solve problems with a high degree of accuracy (e.g., within a defined percentage range or above an accuracy threshold) and resilience on a large scale. An intelligent system may perform one or more computer-implemented intelligent operations that approximate a human thought process while enabling a user or a computing system to interact in a more natural manner. An intelligent system may use AI logic, such as NLP based logic, for example, and machine learning logic, which may be provided as specialized hardware, software executed on hardware, or any combination of specialized hardware and software executed on hardware. The logic of the intelligent system may implement the intelligent operation(s), examples of which include, but are not limited to, question answering, identification of related concepts within different portions of content in a corpus, and intelligent search algorithms, such as Internet web page searches.

In general, such intelligent systems are able to perform the following functions: 1) Navigate the complexities of human language and understanding; 2) Ingest and process vast amounts of structured and unstructured data; 3) Generate and evaluate hypotheses; 4) Weigh and evaluate responses that are based only on relevant evidence; 5) Provide situation-specific advice, insights, estimations, determinations, evaluations, calculations, and guidance; 6) Improve knowledge and learn with each iteration and interaction through machine learning processes; 7) Enable decision making at the point of impact (contextual guidance); 8) Scale in proportion to a task, process, or operation; 9) Extend and magnify human expertise and intelligent; 10) Identify resonating, human-like attributes and traits from natural language; 11) Deduce various language specific or agnostic attributes from natural language; 12) Memorize and recall relevant data points (images, text, voice) (e.g., a high degree of relevant recollection from data points (images, text, voice) (memorization and recall)); and/or 13) Predict and sense with situational awareness operations that mimic human intelligent based on experiences.

Other examples of various aspects of the illustrated embodiments, and corresponding benefits, will be described further herein.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

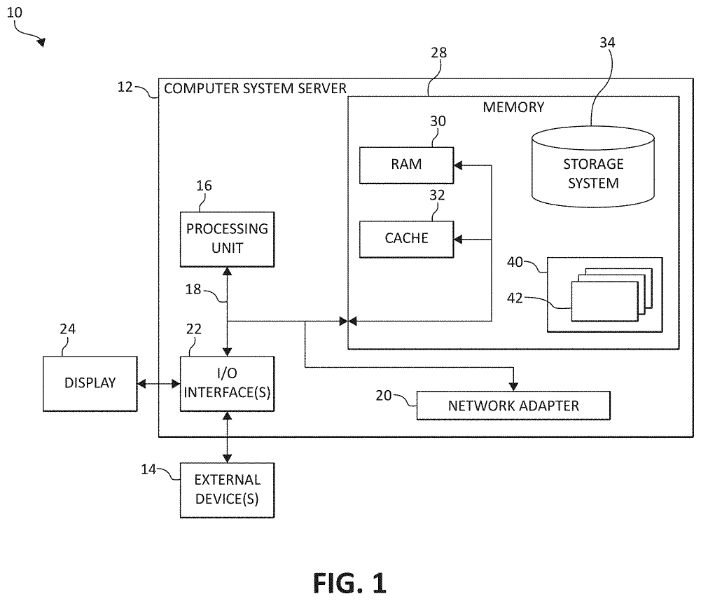

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, system memory 28 may include at least one program product having a set (e.g., at least one) of program modules that are configured to carry out the functions of embodiments of the invention.

Program/utility 40, having a set (at least one) of program modules 42, may be stored in system memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

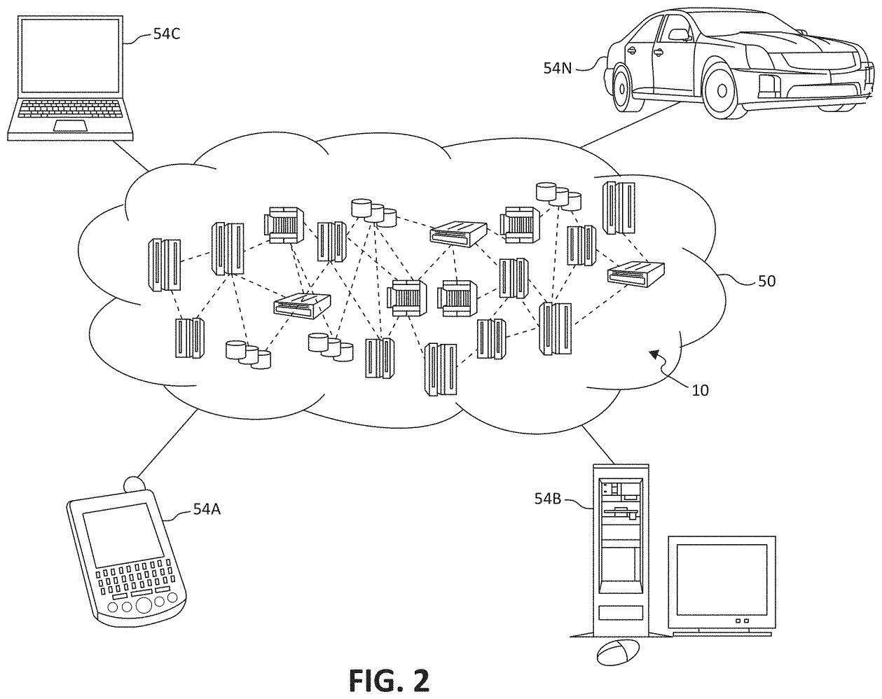

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

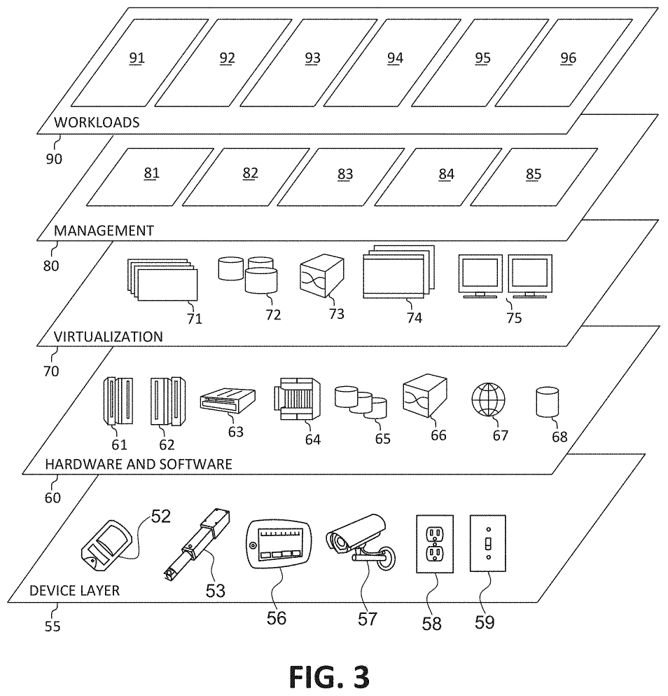

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Device layer 55 includes physical and/or virtual devices, embedded with and/or standalone electronics, sensors, actuators, and other objects to perform various tasks in a cloud computing environment 50. Each of the devices in the device layer 55 incorporates networking capability to other functional abstraction layers such that information obtained from the devices may be provided thereto, and/or information from the other abstraction layers may be provided to the devices. In one embodiment, the various devices inclusive of the device layer 55 may incorporate a network of entities collectively known as the “internet of things” (IoT). Such a network of entities allows for intercommunication, collection, and dissemination of data to accomplish a great variety of purposes, as one of ordinary skill in the art will appreciate.

Device layer 55 as shown includes sensor 52, actuator 53, “learning” thermostat 56 with integrated processing, sensor, and networking electronics, camera 57, controllable household outlet/receptacle 58, and controllable electrical switch 59 as shown. Other possible devices may include, but are not limited to various additional sensor devices, networking devices, electronics devices (such as a remote-control device), additional actuator devices, so called “smart” appliances such as a refrigerator or washer/dryer, and a wide variety of other possible interconnected objects.

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, in the context of the illustrated embodiments of the present invention, various intelligent causal knowledge analysis and/or extraction workloads and functions 96. In addition, intelligent causal knowledge analysis and/or extraction workloads and functions 96 may include such operations as data analytics, data analysis, and as will be further described, notification functionality. One of ordinary skill in the art will appreciate that the intelligent causal knowledge analysis and/or extraction workloads and functions 96 may also work in conjunction with other portions of the various abstraction layers, such as those in hardware and software 60, virtualization 70, management 80, and other workloads 90 (such as data analytics processing 94, for example) to accomplish the various purposes of the illustrated embodiments of the present invention.

As previously mentioned, the mechanisms of the illustrated embodiments provide novel approaches for a system for extraction and analysis of causal knowledge from a corpus of text data such as, for example, millions of news articles, journals, papers, and/or reports. In one aspect, the present invention performs an extraction of causal statements from a text corpus. A collection of application programming interfaces (“APIs”) may be provided for causal analysis and retrieval. Each of the APIs enable searching for the effects of a given cause (or causes of a given effect), as well as an analysis of existence of causal relation given a pair of text data (e.g., words, clauses, phrases, sentences, etc.). The causal analysis operation may include providing a score (e.g., a confidence score) indicating a degree of likelihood/accuracy of the existence of a causal relation. The causal analysis operation also provides evidences from the corpus of text data explains why a causal relation may exist between the input text data (e.g., words, clauses, phrases, sentences, etc.). In one aspect, a machine learning operation (e.g., unsupervised and supervised operations) of causal relation extraction may be performed without imposing semantic constraints on causes and effects.

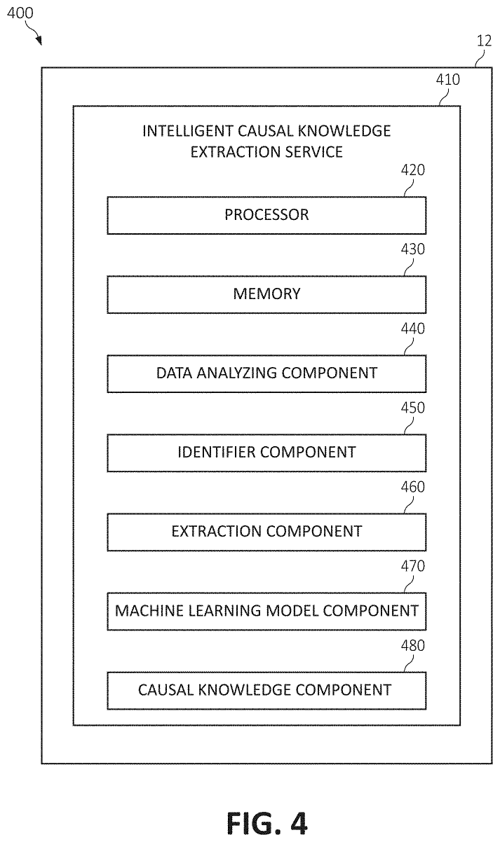

Turning now to FIG. 4 a block diagram depicting exemplary functional components 400 according to various mechanisms of the illustrated embodiments is shown. FIG. 4 illustrates systems 400 for intelligent causal knowledge analysis and/or extraction. As will be seen, many of the functional blocks may also be considered “modules” or “components” of functionality, in the same descriptive sense as has been previously described in FIGS. 1-3. With the foregoing in mind, the module/component blocks 400 may also be incorporated into various hardware and software components of a system for intelligent causal knowledge extraction in accordance with the present invention. Many of the functional blocks 400 may execute as background processes on various components, either in distributed computing components, or on the user device, or elsewhere.

As illustrated in FIG. 4, intelligent causal knowledge extraction service 410 is shown, incorporating processing unit 420 (“processors) and memory 430, which may also be the processing unit 16 (“processor”) and memory 28 of FIG. 1, to perform various computational, data processing and other functionality in accordance with various aspects of the present invention. The processing unit 420 may be in communication with memory 430. The intelligent causal knowledge extraction service 410 may be provided by the computer system/server 12 of FIG. 1.

As one of ordinary skill in the art will appreciate, the depiction of the various functional units in the intelligent causal knowledge extraction service 410 is for purposes of illustration, as the functional units may be located within the intelligent causal knowledge extraction service 410 or elsewhere within and/or between distributed computing components.

The intelligent causal knowledge extraction service 410 may include a data analyzing component 440, an identifier component 450, an extraction component 460, a machine learning model component 470, and a causal knowledge component 480.

In one embodiment, by way of example only, the data analyzing component 440 and the identifier component 450 may analyze and identify structured and/or unstructured data such as, for example, a plurality of communications (e.g., words, clauses, phrases, sentences, statements, messages, etc.) from one or more data sources. The data sources may be provided as a corpus or group of data sources defined and/or identified. The data sources may include, but are not limited to, data sources relating to one or more documents, materials related to emails, books, scientific papers, online journals, journals, articles, drafts, audio data, video data, and/or other various documents or data sources capable of being published, displayed, interpreted, transcribed, or reduced to text data. The data sources may be all of the same type, for example, pages or articles in a wiki or pages of a blog. Alternatively, the data sources may be of different types, such as word documents, wilds, web pages, power points, printable document format, or any document capable of being analyzed by a natural language processing system.

In addition to text based documents, other data sources such as audio, video or image sources may also be used wherein the audio, video or image sources may be pre-analyzed to extract or transcribe their content for natural language processing (via the machine learning component 470, such as converting from audio to text and/or image analysis. For example, a voice command issued by a content contributor may be detected by a voice-activated detection device 404 and record each voice command or communication. The recorded voice command/communication may then be transcribed into text data for natural language processing (“NLP”) and artificial intelligence (AI) to provide processed content.

The data sources may be analyzed by the data analyzing component 440 and the identifier component 450 to data mine or transcribe relevant information from the content of the data sources (e.g., documents, emails, reports, notes, audio records, video recordings, live-streaming communications, etc.) in order to display the information in a more usable manner and/or provide the information in a more searchable manner.

The extraction component 460 may extract one or more causal statements having a cause-effect relationship from the plurality of communications.

The causal knowledge component 480 may classify each of the plurality of communications as being the one or more causal statements or non-causal statement. The causal knowledge component 480 (and in association with the machine learning component 470) may perform an NLP operation on the communications to identify the one or more causal statements where one or more data sources include a corpus of text data.

The causal knowledge component 480 may create an index of a list of a plurality of causal statements collected of a selected period of time, wherein the index is enabled to perform a search operation for a defined query. The causal knowledge component 480 may create cause-effect relationship graphs having a plurality of nodes and edges representing the one or more causal statements having the cause-effect relationship.

The causal knowledge component 480, in association with the identifier component 450, may identify a frequency of occurrence of each of the one or more causal statements, and/or assign a confidence score to the one or more causal statements indicating a degree of accuracy for the cause-effect relationship.

The causal knowledge component 480 may provide the one or more causal statements to a received cause-effect relationship query void of semantic constraints.

The machine learning component 470 may initiate a machine learning mechanism to 1) train a cause-effect relationship model for learning the cause-effect relationship to identify the one or more causal statements, 2) identify one or more semantic similarities between the plurality of communications, and/or 3) identify one or more paths in a cause-effect relationship graph representing the one or more causal statements having the cause-effect relationship relating to a received cause-effect relationship query.

By way of example only, the machine learning component 470 may determine one or more heuristics and machine learning based models using a wide variety of combinations of methods, such as supervised learning, unsupervised learning, temporal difference learning, reinforcement learning and so forth. Some non-limiting examples of supervised learning which may be used with the present technology include AODE (averaged one-dependence estimators), artificial neural networks, Bayesian statistics, naive Bayes classifier, Bayesian network, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher's linear discriminant, logistic regression, perceptron, support vector machines, quadratic classifiers, k-nearest neighbor, hidden Markov models and boosting. Some non-limiting examples of unsupervised learning which may be used with the present technology include artificial neural network, data clustering, expectation-maximization, self-organizing map, radial basis function network, vector quantization, generative topographic map, information bottleneck method, IBSEAD (distributed autonomous entity systems based interaction), association rule learning, apriori algorithm, eclat algorithm, FP-growth algorithm, hierarchical clustering, single-linkage clustering, conceptual clustering, partitional clustering, k-means algorithm, fuzzy clustering, and reinforcement learning. Some non-limiting examples of temporal difference learning may include Q-learning and learning automata. Specific details regarding any of the examples of supervised, unsupervised, temporal difference or other machine learning described in this paragraph are known and are considered to be within the scope of this disclosure. The machine learning operations may include various AI instances. These AI instances may include IBM® Watson® Alchemy Language. (IBM Watson and Alchemy are trademarks of International Business Machines Corporation).

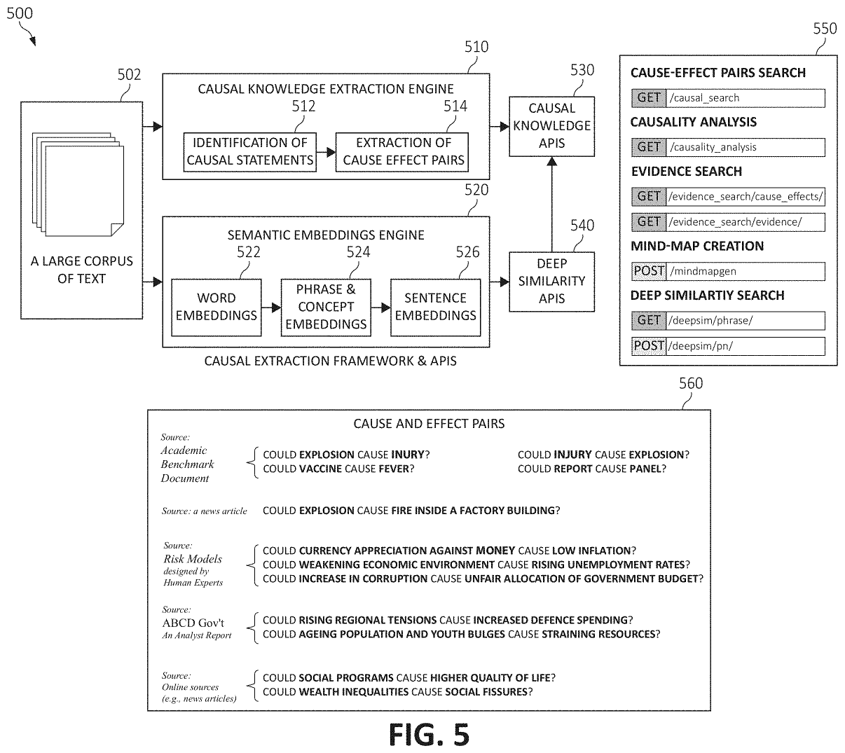

Turning now to FIG. 5, block diagram depicting exemplary functional components 500 according to various mechanisms of the illustrated embodiments is shown. FIG. 5 illustrates system 500 for intelligent causal knowledge analysis and/or extraction. Said differently, FIG. 5 depicts a causal extraction framework 500. As will be seen, many of the functional blocks may also be considered “modules” or “components” of functionality, in the same descriptive sense as has been previously described in FIGS. 1-4. With the foregoing in mind, the module/component blocks 500 may also be incorporated into various hardware and software components of a system for intelligent causal knowledge analysis and/or extraction in accordance with the present invention. Repetitive description of like elements, components, modules, services, applications, and/or functions employed in other embodiments described herein is omitted for sake of brevity.

As illustrated, the system 500 for intelligent causal knowledge analysis and/or extraction may include a corpus of text data 502, a causal knowledge extraction engine 510, a semantic embeddings engine 520, causal knowledge APIs 530, and deep similarity APIs 540.

In one aspect, input data may a large corpus of text data (e.g., documents) 502. The corpus of text data 502 may be digest and turned into a large collection of words, clauses, sentences, and/or phrases that are in turn used in the causal knowledge extraction engine 510 and the semantic embeddings engine 520. The ingestion and processing may be performed in parallel on a distributed processing framework.

The causal knowledge extraction engine 510 may identify causal sentences that may be identified and/or interpreted as causal statements, as in block 512, and then extracts cause and effect pairs, as in block 514, such as, for example, text spans and phrases (e.g., words, clauses, and/or phrases) from these sentences, which may be performed using a rule-based approach for detection of causal sentences. Such operations are opposed to an approach relying on more complex deep parsing since: 1) more complex operations do not scale to hundreds of millions of documents and billions of sentences, and 2) given the large size of the input corpus, the causal knowledge extraction engine 510 may rely on frequency and statistical analysis to identify noise.

The rule-based approach may rely on a dictionary, ontology, or domain knowledge of causal verbs (or discourse cues). The causal knowledge extraction engine 510 may then transform, edit, and/or modify the sentences into one or more (X, Y) pairs where X and Y are text spans or phrases. For phrase extraction, the causal knowledge extraction engine 510 may use a number of operations based on regular expressions on top of part-of-speech tagging in addition to a built-in function of a natural language processing operation. The output of the causal knowledge extraction engine 510 may be a collection of cause-effect pairs along with meta-data identifying a data source and sentence and the phrase extraction operation (if any). This output may be indexed on a distributed Information Retrieval (IR) engine that enables full-text search on all the fields.

The semantic embeddings engine 520 may process a variety of representations of causes and effects statements in natural language and enable effective retrieval and analysis of the extracted cause-effect pairs (from block 514). The semantic embeddings engine 520 may use the corpus of text data 502 to build a distributed representations of word embeddings 522, phrase and concept embeddings 524, and sentence embeddings 526 (e.g., words, phrases, and sentences) in the corpus of text data 502.

In one aspect, by way of example, only, for building a distributed representations for words (e.g., word embeddings 522), a group of related models may be used to produce word embeddings (e.g., use word2vec). For building a distributed representations for phrases (e.g., phrase and concept embeddings 524), an adaptation of word2vec may be used by treating each sentence as a set of phrases and building embeddings that do not take the order of the phrases or the length of the sentence into account. For building a distributed representations for sentences (e.g., sentence embeddings 526), a language representation models (e.g., BERT based embeddings) may be used. The vectors are then indexed using a highly efficient nearest neighbor search index.

The causal knowledge APIs 530 and/or deep similarity APIs 540 functions may be used and implemented in a variety ways using the various API functions outlined in block 550 (e.g., searching cause-effect pairs, causality analysis, evidence search, mind-map creation, and deep similarity search).

For cause-effect pair searches, the cause-effect pair API of block 550 enables searching for 1) effects of a given cause, 2) causes of a given effect, and/or 3) mentions of a given cause-effect pair. The parameters for the search may include, for example, a cause and effect (each could be “*” that indicates (“any”), a query type (e.g., “and” or “OR”), a data source (e.g., news articles corpus), a field (e.g., “title” or “body”), a phrase extraction operation for input cause and effect (if any), a phrase extraction operation used for cause-effect pairs extraction (if any), and/or an extension operation along with parameters (e.g., phrase embeddings along with model parameters).

For searching for cause-effect evidence/proof, the evidence API of block 500 may be similar to the causal knowledge APIs 530 and/or deep similarity APIs 540 and be used with the same input parameters may be used/employed and return groups of source sentences along with meta-data (e.g., a URL of the news article).

The causal analysis API of block 550 also takes in a cause-effect pair with the same parameters as the above APIs and returns a “causality score” in addition to the list of cause-effect pairs as evidences in the input corpus. The causality score may be determined/calculated in a number of different operations, which is an additional input parameter. For example, one operation of calculating (e.g., “operation 1”) the causality score is by dividing a number of hits founds for the cause-effect pair (X, Y) by the number of hits found for the cause-effect pair (Y,X). This is based on the intuition that if X causes Y, it is less likely that Y causes X.

In an additional example (e.g., “Operation 2”), the operation of calculating the causality score may use sentence embeddings and returns the average similarity of the top-k causal sentences to an input sentence such as, for example, “X may cause Y” constructed from the input pair (where “k” is a positive integer or defined value). The intuition for this score is that if X causes Y, the constructed sentence may have a number of highly similar causal sentences in the index of causal sentences.

A third approach for calculating the causality score may be a combination of the first two operations (e.g., operation 1 and operation 2) for calculating the causality score, where the average similarity score of operation 2 is divided by the average similarity of the top-k causal sentences to a constructed sentence like “Y may cause X”.

The mind map creation API, depicted in block 550, may be used to create a graph of causal knowledge given a small number of keywords to define the domain. The mind map creation API may use variations of the input keywords to query for cause-effect pairs with a high “causality score.” The output of this mind map creation API can be turned into a “mind map” for visualization.

Using the various API functions of block 550, the input the corpus of text data 502 may be a collection of a variety of text data such as, for example, millions of articles crawled from various public data sources. For examples, the data source may be from academic benchmarks as well as cause-effect pairs and derived from enterprise and government risk analysis and health related documents. Thus, block 560 depicts various cause and effect pairs identified, extracted, and/or linked together to the causal knowledge. For example, a first data input may be a document have a defined number of tasks, that may be identified from a defined data source (e.g., an academic benchmark document of text data 502).

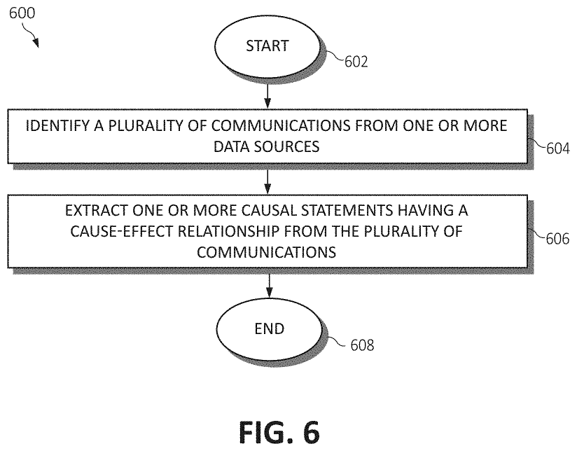

Turning now to FIG. 6, a method 600 for providing intelligent causal knowledge analysis and/or extraction from data sources by a processor is depicted, in which various aspects of the illustrated embodiments may be implemented. The functionality 600 may be implemented as a method executed as instructions on a machine, where the instructions are included on at least one computer readable medium or one non-transitory machine-readable storage medium. As one of ordinary skill in the art will appreciate, the various steps depicted in method 600 may be completed in an order or version differing from the depicted embodiment to suit a particular scenario. The functionality 600 may start in block 602.

Multiple communications (e.g., structured and/or unstructured data) may be identified from one or more data sources, as in block 604. One or more causal statements having a cause-effect relationship from the plurality of communications, as in block 606. The functionality 600 may end in block 608.

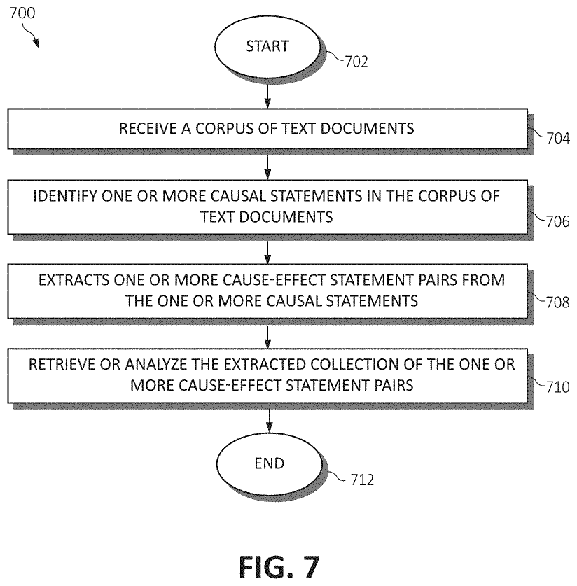

Turning now to FIG. 7, an additional method 700 for providing intelligent causal knowledge analysis and/or extraction from one or more data sources by a processor is depicted, in which various aspects of the illustrated embodiments may be implemented. The functionality 700 may be implemented as a method executed as instructions on a machine, where the instructions are included on at least one computer readable medium or one non-transitory machine-readable storage medium. As one of ordinary skill in the art will appreciate, the various steps depicted in method 600 may be completed in an order or version differing from the depicted embodiment to suit a particular scenario. The functionality 700 may start in block 702.

A corpus of text documents may be received (e.g., as input data), as in block 704. One or more causal statements may be identified in the corpus of text documents, as in block 706. One or more cause-effect statement pairs may be extracted from the one or more causal statements, as in block 708. The extracted collection of the one or more cause-effect statement pairs may be retrieved and/or analyzed, as in block 710. The functionality 700 may end in block 712.

In one aspect, in conjunction with and/or as part of at least one block of FIGS. 6-7, the operations of methods 600 and 700 may include each of the following. The operations of methods 600 and 700 may classify each of the communications as being the one or more causal statements or non-causal statement and/or perform an NLP operation on the plurality of communications to identify the one or more causal statements, wherein the one or more data sources include a corpus of text data. The operations of methods 600 and 700 may create an index of a list of a plurality of causal statements collected of a selected period of time where index is enabled to perform a search operation for a defined query. The operations of methods 600 and 700 may create a cause-effect relationship graph having a plurality of nodes and edges representing the one or more causal statements having the cause-effect relationship.

The operations of methods 600 and 700 may identify a frequency of occurrence of each of the one or more causal statements, assign a confidence score to the one or more causal statements indicating a degree of accuracy for the cause-effect relationship, and/or provide the one or more causal statements to a received cause-effect relationship query void of semantic constraints.

The operations of methods 600 and 700 may initiate a machine learning mechanism to 1) train a cause-effect relationship model for learning the cause-effect relationship to identify the one or more causal statements, 2) identify one or more semantic similarities between the plurality of communications, and 3) identify one or more paths in a cause-effect relationship graph representing the one or more causal statements having the cause-effect relationship relating to a received cause-effect relationship query.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowcharts and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowcharts and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

1. A method for intelligent causal knowledge analysis from a data source in a computing system by a processor, comprising:
identifying a plurality of communications from one or more data sources; and
extracting one or more causal statements having a cause-effect relationship from the plurality of communications.

2. The method of claim 1, further including classifying each of the plurality of communications as being the one or more causal statements or non-causal statements.

3. The method of claim 1, further including performing a natural language processing (“NLP”) operation on the plurality of communications to identify the one or more causal statements, wherein the one or more data sources include a corpus of text data.

4. The method of claim 1, further including:
creating an index of a list of a plurality of causal statements collected of a selected period of time, wherein the index is enabled to perform a search operation for a defined query; or
creating a cause-effect relationship graphs having a plurality of nodes and edges representing the one or more causal statements having the cause-effect relationship.

5. The method of claim 1, further including:
identifying a frequency of occurrence of each of the one or more causal statements; or
assigning a confidence score to the one or more causal statements indicating a degree of accuracy for the cause-effect relationship.

6. The method of claim 1, further including providing the one or more causal statements to a received cause-effect relationship query void of semantic constraints.

7. The method of claim 1, further including initiating a machine learning mechanism to:
training a cause-effect relationship model for learning the cause-effect relationship to identify the one or more causal statements;
identifying one or more semantic similarities between the plurality of communications; and
identifying one or more paths in a cause-effect relationship graph representing the one or more causal statements having the cause-effect relationship relating to a received cause-effect relationship query.

8. A system for intelligent causal knowledge analysis from a data source in a computing system, comprising:
one or more computers with executable instructions that when executed cause the system to:
identify a plurality of communications from one or more data sources; and
extract one or more causal statements having a cause-effect relationship from the plurality of communications.

9. The system of claim 8, wherein the executable instructions further classify each of the plurality of communications as being the one or more causal statements or non-causal statements.

10. The system of claim 8, wherein the executable instructions further perform a natural language processing (“NLP”) operation on the plurality of communications to identify the one or more causal statements, wherein the one or more data sources include a corpus of text data.

11. The system of claim 8, wherein the executable instructions further:
create an index of a list of a plurality of causal statements collected of a selected period of time, wherein the index is enabled to perform a search operation for a defined query; or
creates cause-effect relationship graphs having a plurality of nodes and edges representing the one or more causal statements having the cause-effect relationship.

12. The system of claim 8, wherein the executable instructions further:
identify a frequency of occurrence of each of the one or more causal statements; or
assign a confidence score to the one or more causal statements indicating a degree of accuracy for the cause-effect relationship.

13. The system of claim 8, wherein the executable instructions further provide the one or more causal statements to a received cause-effect relationship query void of semantic constraints.

14. The system of claim 8, wherein the executable instructions further initiate a machine learning mechanism to:
train a cause-effect relationship model for learning the cause-effect relationship to identify the one or more causal statements;
identify one or more semantic similarities between the plurality of communications; and
identify one or more paths in a cause-effect relationship graph representing the one or more causal statements having the cause-effect relationship relating to a received cause-effect relationship query.

15. A computer program product for intelligent causal knowledge analysis from a data source by a processor, the computer program product comprising a non-transitory computer-readable storage medium having computer-readable program code portions stored therein, the computer-readable program code portions comprising:
an executable portion that identifies a plurality of communications from one or more data sources; and
an executable portion that extracts one or more causal statements having a cause-effect relationship from the plurality of communications.

16. The computer program product of claim 15, further including an executable portion that classifies each of the plurality of communications as being the one or more causal statements or non-causal statements.

17. The computer program product of claim 15, further including an executable portion that performs a natural language processing (“NLP”) operation on the plurality of communications to identify the one or more causal statements, wherein the one or more data sources include a corpus of text data.

18. The computer program product of claim 15, further including an executable portion:
creates an index of a list of a plurality of causal statements collected of a selected period of time, wherein the index is enabled to perform a search operation for a defined query; or
creates a cause-effect relationship graphs having a plurality of nodes and edges representing the one or more causal statements having the cause-effect relationship.

19. The computer program product of claim 15, further including an executable portion:
identifies a frequency of occurrence of each of the one or more causal statements;
assigns a confidence score to the one or more causal statements indicating a degree of accuracy for the cause-effect relationship; or
provides the one or more causal statements to a received cause-effect relationship query void of semantic constraints.

20. The computer program product of claim 15, further including an executable portion initiate a machine learning mechanism to:
trains a cause-effect relationship model for learning the cause-effect relationship to identify the one or more causal statements;
identifies one or more semantic similarities between the plurality of communications; and
identifies one or more paths in a cause-effect relationship graph representing the one or more causal statements having the cause-effect relationship relating to a received cause-effect relationship query.
